(19) United States
(12) Patent Application Publication
(10) Pub. No.: US 2006/0030396 A1
(43) Pub. Date: Feb. 9, 2006

(54) Gaming apparatus and method including bonus features

(76) Inventors: Howard M. Marks, Westport, CT (US); Anthony M. Singer, Ringwood, NJ (US); Daniel M. Marks, Brooklyn, NY (US)

Correspondence Address: MORISHITA LAW FIRM, LLC, 3800 HOWARD HUGHES PARKWAY, SUITE 850, LAS VEGAS, NV, 89109, US

(21) Appl. No.: 09/944,533

(22) Filed: Aug. 31, 2001

(51) Int. Cl. A63F 13/00

(52) U.S. Cl. 463/20

(57) ABSTRACT

An electronic slot machine game is set forth which includes an on-screen bonus and one or more separate screen bonuses. A processor randomly selects to activate a coordinate of a game matrix having one or more pay lines. The coordinate remains activated until a bonus is triggered. When a triggering symbol is randomly assigned to an activated coordinate, an on-screen bonus is issued. When the bonus is issued, all activated coordinates are de-activated. The bonus is related to the amount wagered to play the game, the number of activated coordinates and assigned values or multipliers. Second screen bonuses are triggered by scattered symbols or symbols on enabled pay lines and include a game themed screen for the player to select from a plurality of hidden bonuses or issues a random bonus accompanied by an entertaining video segment.

### FIELD OF THE INVENTION

The present invention relates to electronic gaming devices and methods using selected and displayed symbol combinations to determine winning and losing outcomes and where bonus features are provided. More particularly it relates to such apparatus and methods which include a bonus which remains activated until triggered by one or more predetermined outcomes.

### BACKGROUND

Video slot machines are well known and are quite popular with players. In a basic form, the player makes a wager to play the game and enables one or more pay lines on a video display. Upon prompting play, a processor selects and displays game symbols on the display in a matrix form. The symbols on any enabled pay line are compared to a schedule of winning outcomes to determine if a winning or a losing outcome have been obtained. Where a winning outcome is obtained the player receives an award based upon an established pay table for the game. The player then makes another wager, enables one or more pay lines and plays another game (often referred to as a “hand” or “spin”).

The awards issued can be game credits, prizes or the like. For actual casino games, the awards correspond to a monetary amount or a physical prize. For novelty versions of these games, the award is simply accumulation of game credits.

To make such games more entertaining, it is known to provide certain configurations of bonuses. The bonus may be triggered by a certain combination of symbols on a pay line or scattered on the display (a “scatter prize”). It is also known to provide secondary screens for issuing a bonus. That is, when the player obtains a certain, predetermined outcome, the game processor displays a secondary screen where the player can select from certain options to obtain their bonus. For example, in one game, the player selects by a touch screen from between several displayed “pigs”, the selected pig, in an animated fashion, revealing the bonus. The bonus can be a fixed amount, usually a function of the amount wagered, or a multiplier which multiplies the amount won.

There is a need for a new game which provides for new and different bonuses to enhance the entertainment value of the game for the player. There is a need for a game which provides for activating a bonus condition, the bonus fulfilled in the same or a later spin by obtaining a trigger outcome. This feature encourages the player to continue to play as excitement builds to fulfil and obtain the bonus.

There is also a need for a game which includes multiple bonus offerings for a primary game wherein the primary game and bonuses can be cooperatively themed.

### SUMMARY OF THE INVENTION

There is, therefore, set forth according to the present invention an apparatus and method for playing an electronic game which provides winning and losing outcomes and one or more bonus outcomes, one of which includes an on-screen bonus including a bonus activator to activate a bonus condition for the game and a bonus trigger which, when matched with an activated bonus condition, triggers a bonus. There are also set forth one or more additional, different screen bonuses for the game, all of which can have a cooperative theme.

According to one embodiment, an electronic apparatus and method for playing a casino game according to the present invention are set forth which includes a video display to display the primary game action. A data structure stores data corresponding to game symbols. The symbols used may be consistent with the theme of the game, numbers, fruit, or other symbols or indicia which may be desired. The game processor also includes means for each spin of the game, randomly selecting (or not selecting, based upon a pre-programmed statistical probabilities) to activate a coordinate of the displayed primary game matrix for enabling an on-screen bonus. For example, when a coordinate is activated, an activator symbol such as a symbol of a jail cell may be displayed in the primary game matrix. To control the display and game action the processor is provided with an input device to prompt the processor for each play of successive hands. When the processor is prompted it is configured to randomly select from the data structure and assign game symbols into the coordinates of the X by Y game matrix as well as, if selected, activate a coordinate for a bonus. The matrix may be displayed in a fashion to present side-by-side strips of rotating slot machine reels such as by presenting a 3×5 matrix representing five reels each displaying three symbols. Where a coordinate becomes activated, it is preferably displayed in some fashion to inform the player that the coordinate has been activated; however, it may be a hidden symbol. Where bonus activator data or influence has been assigned to one or more coordinates, the processor is configured to maintain any activated coordinate active until a bonus is triggered.

The processor compares selected and displayed game symbol combinations assigned into the game matrix to determine winning or losing combinations. Where the game is a casino game, means are provided for a player to input a wager to enable one or more pay lines on the game matrix as is known in the art. Winning combinations, for the casino game, are typically those aligned along enabled pay lines. However, scattered prizes may be awarded as well. In determining winning or losing outcomes of game symbols, the activation of any coordinate is ignored. For winning outcomes, an award or pay off is provided to the player.

Where a coordinate has been activated, the processor issues an on-screen bonus award when a bonus triggering symbol is selected and assigned to an activated coordinate. For example, where the activated coordinate in the game matrix is represented by a symbol of a jail cell and the trigger game symbol data represents a depiction of a reward symbol, such as a depiction of an outlaw, if the outlaw is assigned to an activated coordinate, i.e. put in jail, the player is issued a bonus. For regular game symbols, they are visible though the bars of the jail cell. Triggering of the bonus may occur in the same spin as activation of the triggered coordinate or in a latter spin. Once a bonus is triggered the triggered activated coordinate or all activated coordinates are de-activated.

An additional embodiment includes changing the amount of the bonus as determined by one or more of the values of the triggering symbol data assigned to trigger the bonus and/or the number of activated coordinates.

Still further embodiments of the apparatus and method of the present invention provide for other bonuses such as including bonuses triggered by selection and display of one or more bonus or scatter bonus symbols. When such bonuses are triggered the processor is programmed to display player interactive bonus screens for the player to make selections to receive a bonus.

Accordingly the apparatus and method of the present invention provides a base game where a player can obtain winning combinations with game symbols and a game where a player can win one or more different bonuses. For the one bonus related to activation of a matrix coordinate, the game provides for excitement of play as well as extended play as the player tries to obtain a bonus trigger in one or more activated coordinates.

### BRIEF DESCRIPTION OF THE DRAWINGS

These and other features and advantages will become appreciated as the same becomes understood with reference to the claims, description and drawings wherein:

FIG. 1 shows a game display and input device for the game of the present invention and certain displayed game and bonus symbols configured to have an Old West theme;

FIG. 2 shows a schedule of exemplar symbols for the game;

FIGS. 3A-D shows the patterns for various pay lines which may be enabled for the game;

FIG. 4 shows the display for the apparatus and method including a displayed activation symbol and triggering symbol for issuance of an on-screen bonus;

FIG. 5 shows a secondary screen for awarding a line bonus;

FIG. 6 shows another secondary screen for awarding a scatter bonus;

FIG. 7 is a flowchart for the game;

FIGS. 8A and B are flowcharts for the on-screen bonus based upon triggering an activated coordinate on the display;

FIG. 9 is a flowchart for the initiation of the second bonus and play display; and

FIG. 10 is a flowchart for the initiation of the third bonus and play display.

### DESCRIPTION

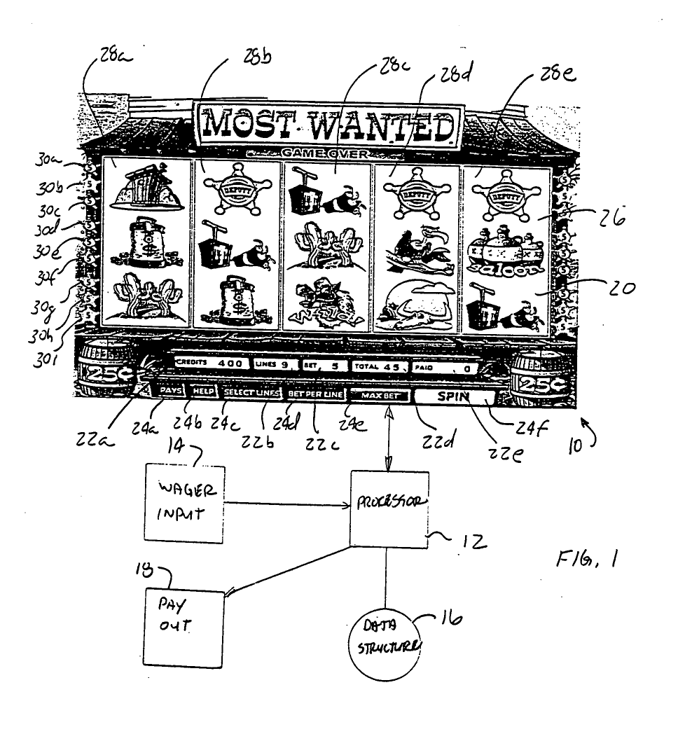

Turning to FIG. 1 there is shown a video display 10 for the apparatus and method game of the present invention. The display 10 may be embodied as a video display 10 for a casino gaming device, computer monitor where the game of the present invention is played for entertainment or through the Internet or the display 10 may be embodied on a hand-held device such as a personal data assistant (PDA) or hand held gaming device or any other suitable and compatible electronic display.

While the following description is directed to a casino gaming apparatus where monetary units or their equivalent, such as accumulated gaming credits, are wagered and won, it should be understood that the method can be practiced as a novelty game where fictitious gaming credits are wagered and won.

The display 10 is contained in a supporting housing (not shown) which includes the various components including a controlling computer processor 12 (including a random number generator), wager accepting means 14, data storage data structure 16 and pay out device 18 of the type generally known in the art. In an alternative optional embodiment the display 10 may communicate with a processor 12 remotely located, such as at a server. Preferably, the display 10 is embodied as a touch screen display which also provides means for the player to control the play of the game. Alternatively, the play control means may be any suitable data input means such as game control buttons, keyboard, mouse or the like. For purposes of the following description, these data input means will be referred to as a touch screen display 10.

The wager accepting means 14 includes one or more of a token/coin acceptor, cash validator and acceptor, credit/debit card reader or other suitable means for a player to make wagers to play the game as is known in the art. The data structure 16 may be embodied as any suitable memory device including a random access memory (RAM), compact disk or other compatible memory device. Finally, the pay out device 18 may be embodied as a hopper to receive coins/tokens and dispense the same, means for accumulating game play credits, a device for writing to a credit voucher, credit card device or the like as is known in the art.

With continuing reference to FIG. 1, the processor 12 controls the display 10 and play of the game of the method. For the player to control the action of the game method, the touch screen display 10 includes a game play area 20 where symbols, displays and screens for play are displayed as well as areas to impart information to the player and for the player to input data to the processor 12. Certain of these areas are allocated for display only and do not provide for touch screen input to the processor 12. For example, credit area 22a on the display 10 displays the total amount of accumulated credits for play of the game. Line area 22b displays the number of enabled pay lines being played by the player and bet area 22c displays the amount of credits wagered per enabled pay line whereas total area 22d displays the total amount of the wager. Paid area 22e displays the total amount paid to the player in coins, tokens or credits, for a winning outcome and/or bonus as hereinafter described.

In addition to the foregoing areas, certain portions of the display 10 define input buttons for inputting information to the processor 10 for controlling the action. Pays button 24a, if touched by the player, prompts the processor 12 to display the various winning outcomes and the pay for each. Help button 24b prompts the processor 12 to display help information to the player such as game instructions. The select lines button 24c enables the player to input data to the processor to enable a player selected number of pay lines on the display 10 and the bet per line button 24d enables the player to input data to the processor to bet a selected amount per line. The max bet button 24e provides for the player to enable all pay lines and enter a maximum wager for the next spin of the game. The spin button 24f, if touched by the player, prompts the processor 12 for the play of the game. The aforementioned input buttons 24a-f and display areas 22a-e are generally known in the art.

The processor 12 is configured to display in the game play area 20, a primary game matrix 26 of coordinates shown for purposes of this description as a three-by-five matrix 26. During play of the method, symbols as hereinafter described are selected and displayed in each coordinate of the matrix 26. As shown in FIG. 1, the matrix 26 may be displayed in a fashion of five simulated slot machine reels 28a-e which correspond to the five columns (Y) of the matrix 26. Each reel 28a-e includes three coordinates (X) defining the primary game matrix 26.

When play of the game is prompted by the player touching spin button 24f or the max bet button 24e, the processor 12 selects and displays data from the data structure 16 storing data representing various symbols to be displayed to define one or more outcomes for the play of a game hand. The selection of game symbols is based, for a casino game, upon a random number generator (RNG). Symbol data is stored and/or selected based upon a predetermined distribution such that each symbol has a predetermined, statistical probability of being selected, as is known in the art. When the symbols are selected they are displayed in the coordinates of the matrix 26. The processor 12 is configured to simulate rotation of the reels 28a-e in advance of the display of the symbols.

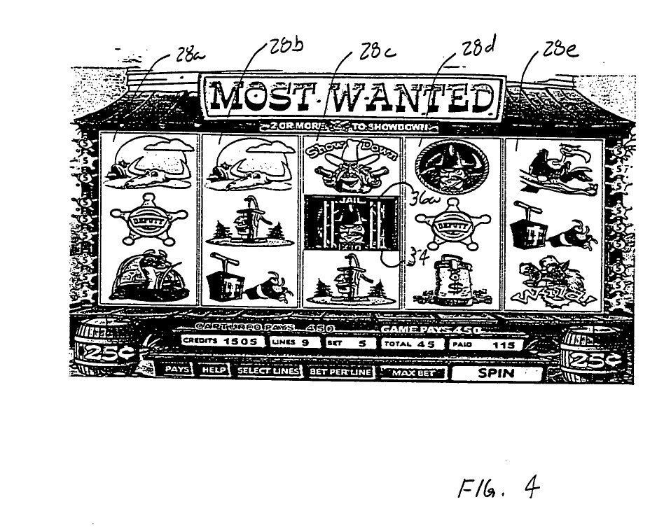

Cooperating with the matrix 26, the processor is configured to display various pay lines for the matrix 26 grid. FIGS. 3A-D shows various patterns of the pay lines which may be enabled for the game method. With reference to FIG. 1, markers 30a-i at the right and left hand margins of the game play area 20 of the display 10 indicate the enabled pay line(s) and the amount wagered per each enabled pay line.

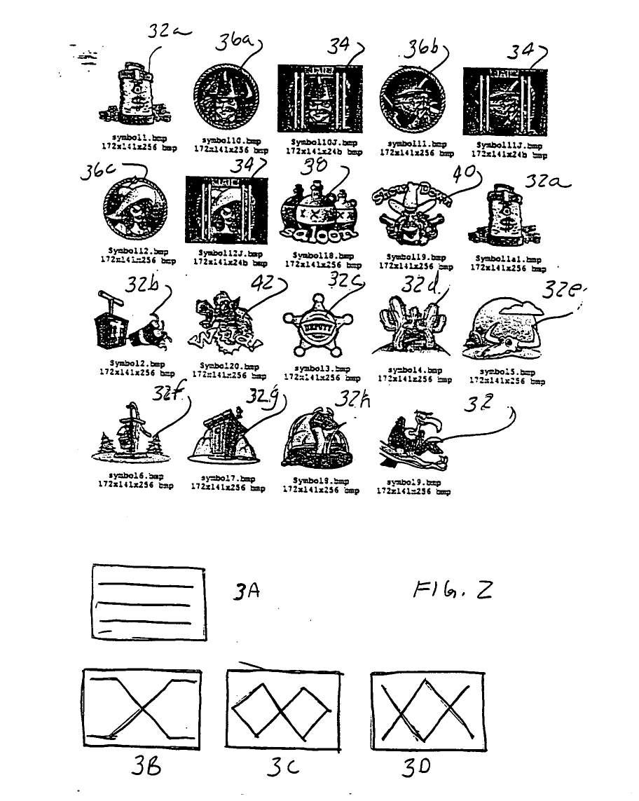

FIG. 2 shows the various symbols for the game of the embodiment showed herein. Certain of the symbols are, for purposes of this description, designated as game symbols 32a-h, bonus activating symbols 34, bonus triggering symbols 36a-c (which may also be game symbols as well), second bonus symbol 38, scatter bonus symbol 40 and a wild symbol 42. For the bonus activating symbols 34, those symbols, consistent with the theme of the game, appear as an empty jail cell, although with respect to FIG. 2 those symbols are shown matched with a bonus triggering symbol 36a-c. Data representing the symbols is stored in the data structure 16.

With the foregoing in mind, the method of the game will now be described.

To start the game, the player enters a wager through the input means 14 to enable and allocate a wager to the desired pay lines. As wagers are made the markers 30a-i are displayed in the display 10 to show which pay lines have been enables and the wager allocated to each enabled pay line. The processor 12 may be configured to have a predetermined hierarchy for enabling pay lines such that they are enabled in a predetermined order, as is known in the art. For purposes of this description, it shall be assumed that all nine pay lines (FIGS. 3A-D) are enabled. Upon enabling the pay lines, play of a game hand, i.e. spin, is prompted by the player touching the spin button 24f. If the player touches the max bet button 24e to enable all pay lines to the maximum amount permitted, play is prompted without touching the spin button 24f. Upon prompting, the processor 12 randomly selects from the data structure 16 data representing a game symbol 32a-h, bonus activating symbol 34, bonus triggering symbol 36a-c, second bonus symbol 38, scatter bonus symbol 40 or a wild symbol 42 for each of the fifteen coordinates of the matrix 26 and displays the selected symbols. In advance of the display of the selected symbols, the processor preferably displays a simulation of the reels 28a-e spinning. FIG. 1 shows an example of the display 10 and game play area 20 upon the selection and display of a hand of play defining a wining or losing outcome for and along each of the enabled pay lines. For example, winning game symbol combinations may be defined as in Table 1 below:

TABLE 1

| | Ref. No. | Number on | Pay out X |
|---|---|---|---|
| Symbol | (FIG. 2) | pay line | line wager |
| Outlaws | 36a-c | 5 | 3750 |
| | | 4 | 750 |
| | | 3 | 250 |
| | | 2 | 45 |
| Money Bag | 32a | 5 | 100 |
| | | 4 | 20 |
| | | 3 | 8 |
| Dynamite Plunger | 32b | 5 | 50 |
| | | 4 | 10 |
| | | 3 | 4 |
| Deputy Badge | 32c | 5 | 75 |
| | | 4 | 15 |
| | | 3 | 6 |
| Cactus | 32d | 5 | 100 |
| | | 4 | 20 |
| | | 3 | 8 |
| Steer Skull | 32e | 5 | 125 |
| | | 4 | 25 |
| | | 3 | 10 |
| Water Pump | 32f | 5 | 1000 |
| | | 4 | 450 |
| | | 3 | 150 |
| | | 2 | 15 |
| Outhouse | 32g | 5 | 1500 |
| | | 4 | 300 |
| | | 3 | 100 |
| Rattlesnake | 32h | 5 | 2250 |
| | | 4 | 450 |
| | | 3 | 150 |
| | | 2 | 15 |
| Vulture | | 5 | 3000 |
| | | 4 | 600 |
| | | 3 | 200 |
| | | 2 | 30 |

The wild symbol 42 is wild for any game symbol.

It should be understood that other pays and symbols can also be used to provide the desired operational characteristics such as overall pay out for the game, as desired.

With reference to FIG. 1, when the symbols for the matrix 26 have been selected, the processor 12 compares the data of the displayed symbols to determine winning and losing combinations. It is seen that there are no winning game symbol combinations along any enabled pay line. Therefore, the player would lose their wager and not receive a payout.

To play subsequent games the player makes another wager and prompts play.

In regards to play the various bonus features will now be described.

Trigger Symbol Lands in Activated Coordinate

According to this bonus feature, the data structure 16 includes data which, when selected by the processor and applied to a coordinate of the matrix 26, activates the coordinate for receiving a bonus trigger symbol 36a-c to trigger a bonus. The activated coordinate(s) remain activated until a bonus is triggered. While the coordinate activation data preferably is associated with an activation symbol such as an empty jail cell according to the embodiment shown, activation of a coordinate need not be displayed in a special fashion or displayed whatsoever. However, to encourage play it is preferable to indicate which coordinate(s) have been and remain activated by selection in one or more previous hands of the aforesaid activation data. For example, the coordinate may be displayed highlighted with a color background, displaying a spot or other indicia. Also preferably, the activation display is transparent or semi-transparent with respect to other game symbols. For example, if a coordinate has been activated by selection of the activation data and a game symbol such as the rattlesnake 32h is selected in a later game hand for the activated coordinate, the rattlesnake will appear though the bars of the cell representing activation of the coordinate. Any game symbols or bonus symbols landing in an activated coordinate can form any winning outcome inasmuch the processor 12 ignores the activation of the cell, and the presence of the activation symbol, for the purpose of determining winning or losing pay line combinations.

More than one coordinate may be activated and the same rules stated above apply to each. Further, as stated above, all activated coordinates remain activated until a bonus condition has been satisfied.

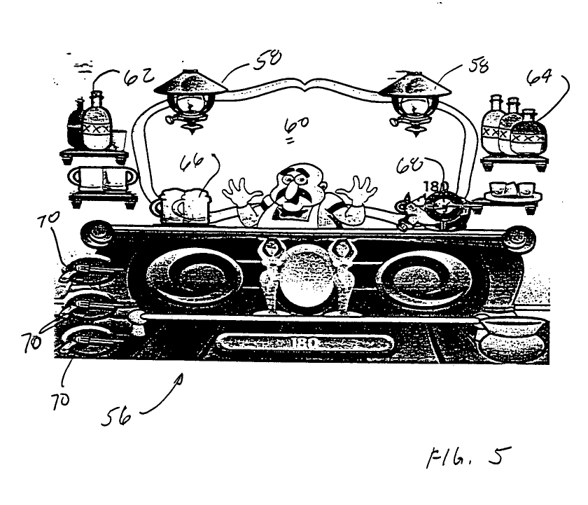

To trigger or satisfy the bonus, a bonus triggering symbol 36a-c must be selected and positioned in a previously activated coordinate. With reference to FIG. 4, this bonus condition has been satisfied by the selection of triggering symbol 36a in the coordinate occupied by the activation symbol (jail cell 34) giving the impression of the capture of an outlaw. More than one coordinate may simultaneously satisfy this bonus condition, i.e. the capture of two or more outlaws on the same spin.

The amount or value V of the bonus paid may be a fixed amount or it may vary based upon the outlaw(s) captured, multipliers assigned to the activation symbols and line or total wager for the spin. Each outlaw 36a-c may have a different value (reward for capture). Further, the amount of the bonus may be related to the value of the captured outlaw as well as the number of coordinates activated at the time of the bonus. For example the bonus issued may be according to the following formula:
Bonus=Σ(V×TW)/N, where Σ(V×TW)=the sum of all bonuses triggered (V) times the total amount wagered for the spin (TW) and N=the number of activated coordinates. Thus, if three coordinates are activated and a bonus is triggered with a single triggering symbol having a value of 300 units, the total amount of the bonus would be 300/3=100 units. Alternatively, as described below, each activated coordinate may be assigned a multiplier. These multipliers may be randomly assigned as the coordinate is activated and the sum of multipliers for activated coordinates may be limited such as by limiting the sum of multiplies to ten. Thus if a single coordinate is activated, it may be assigned a multiplier of ten (10×). If another coordinate is activated, each activated coordinate may be assigned a multiplier of 5× (or 2× and 8×).

None to all five of the reels 28a-e may include an activated coordinate and more than one on-screen bonus may be triggered in a single spin, i.e. two or more outlaws captured. The bonuses are aggregated for a total bonus. The bonuses may be fixed amounts or multipliers wherein the award is the product of the accumulated bonus multipliers awarded and the total wager for the spin.

Once a bonus has been triggered, all activated coordinates (whether triggered or not) in the matrix 26 are deactivated. Alternatively, only triggered coordinates may be deactivated resulting in a multiplier reallocation if necessary.

Pay Line Bonus

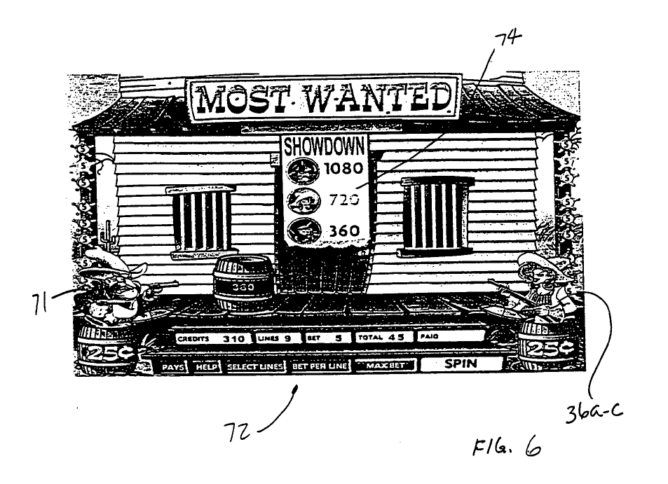

A further feature of the present invention is the feature of a bonus and the method for issuing the bonus. According to this aspect of the method, in the event there are selected and displayed along any enabled pay line any three or more line bonus symbols 38 for a single hand (spin), three scatter bonus symbols, a line bonus prize is awarded. According to the embodiment described herein, if three or more line bonus symbols 38 are selected and displayed along any enabled pay line, the processor is prompted to display a line bonus selection screen 56 as shown in FIG. 5. The screen should be consistent with the overall theme of the game and, according to the example described herein, shows a western saloon scene. In the screen 56 there are displayed certain bonus target objects such as lamps 58, mirror 60, bottles 62, jugs 64, beer mugs 66 and jug 68 (on the bar). The bonus selection screen 56 also displays the number of choices the player has to select bonuses, shown in FIG. 5 as three pistols 70, indicating the player has three choices. By using the touch screen display 10 the player touches certain bonus targets. As each target is touched, the processor displays the target as being shot and reveals a bonus. As each target is touched, the number of displayed pistols 70 is reduced by one, indicating the player selects a total of three bonuses and the target appears to be “shot” resulting in it breaking open and a bonus amount appearing. Upon display of the bonus selection screen 56, various bonus values are randomly assigned to each target, the value of which is based to a degree on the line or total wager made by the player. Further, the value of each assigned bonus may be related to the number, three to five, bonus symbols displayed. Alternatively, each target may reveal a randomly selected total bet multiplier ranging from 2× to 12× (for three bonus symbols 38) to 8× to 48× (for 5 bonus symbols 38).

After all selections have been made by the player (three selections corresponding to three pistols 70 shown in FIG. 5) and the corresponding bonus multipliers revealed, all multipliers are summed and multiplied times the total amount wager for the spin. In the example of FIG. 1, with nine lines enabled and five units wagered per line, the total wager is forty-five units.

Scatter Bonus

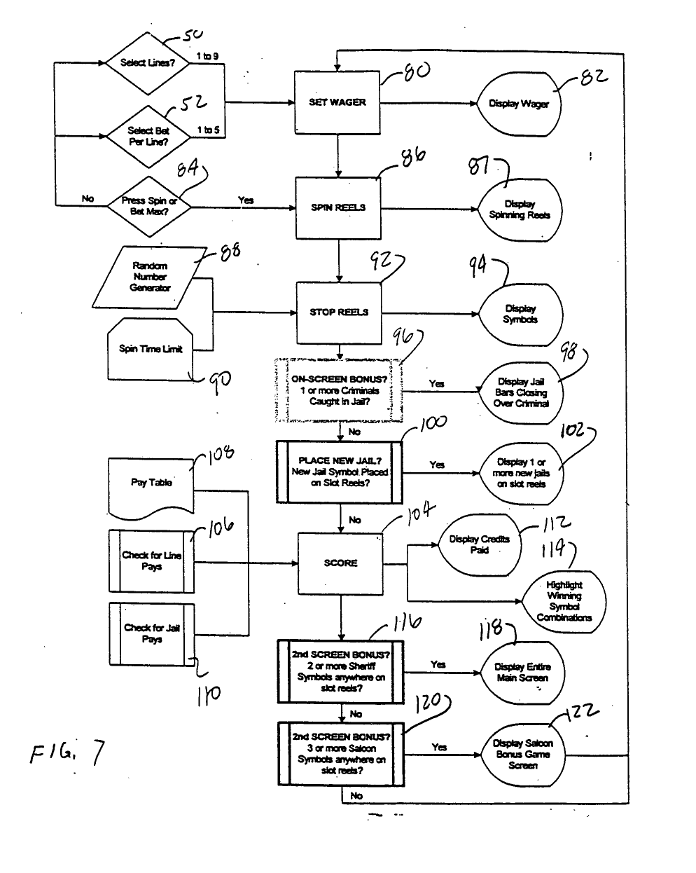

Another bonus which may be provided according to the present invention is a scatter bonus. Scatter bonuses, as is known in the art, provide a bonus when a predetermined number or more of certain selected symbols are displayed in a predetermined fashion on the game display. Some scatter bonuses require a predetermined number, e.g. three, symbols to be displayed on three adjacent reels for the scatter bonus to be awarded. According to the present invention, a scatter bonus is awarded when two of more scatter symbols 40 are selected and displayed at any position on the display 10. In such an event the processor 12 is prompted to display a scatter bonus award screen 72 as shown in FIG. 6. The screen 72 depicts a western scene as a stand-off between a sheriff 71 and a plurality of outlaws positioned in a random sequence in barrels. These outlaws are representative of the outlaws of the bonus triggering symbols 36a-c and are presented in ascending values as is indicated on the poster 74 on the display screen 72. When the processor activates the scatter bonus screen 72, the outlaw is randomly selected and displayed in the barrel to draw against the sheriff 71 and the outcome (sheriff win or outlaw win) is also randomly selected. If the selection is a sheriff loss, the bonus sequence is over and the player may be awarded a conciliation bonus, the processor returning the display 10 to the primary game. If the selection is a sheriff 71 win, the processor 12 controls the display 10 to display defeat of the outlaw and revelation of the bonus, which again may be a value or multiplier of the total wager or, as in this example, the amount shown on poster 74. The next outlaw randomly selected from the stable of outlaws is selected and the winner (sheriff versus outlaw) is selected and processed in the manner above. As awards are issued, the poster 74 reflects the amount, again as a fixed value or a total bet multiplier. If, for any outlaw shootout, the sheriff loses, or the sheriff defeats all outlaws, the accumulated award is issued. At the conclusion of the scatter bonus feature, the processor 12 returns to the primary game.

It should be noted that the player may have simultaneous wins as line combination wins, line bonus, scatter bonus or triggered bonus.

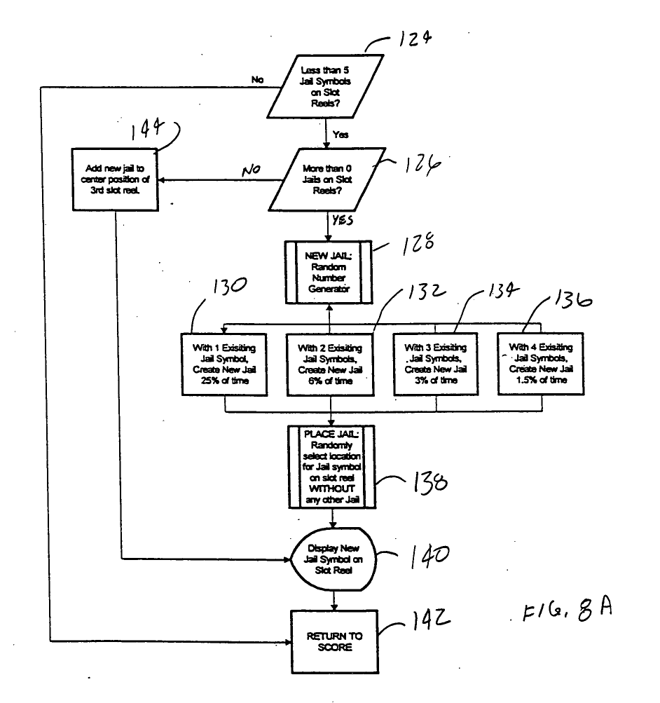

In FIG. 7 there is shown a flow diagram for the overall game. At 50 and 52, the number of lines and amount wagered for each selected are chosen by the player. The processor sets and displays the wager at 80 and 82. The player prompts play of a spin or hand at 84 by pressing the spin button 24f or the max bet button 24e whereupon the processor 12 controls the display 10 to display a simulation of the reels 28a-e spinning at 86, 87 and selects the spin outcome. The processor includes a random number generator 88 the output of which is used to select and apply the data of the data structure 16 to the coordinates of the matrix 26 at the display 10. In a time limit, as set by a spin time limit 90, the reels 28a-e are stopped at 92 and at 94 the selected symbols are displayed for the coordinates of the game matrix 26.

The processor 12 at 96 compares the displayed symbols to determine whether any bonus triggering symbol 36a-c is displayed in an activated coordinate to trigger the bonus. If there is an outlaw captured in a jail cell, i.e. a bonus triggering symbol 36a-c has been selected and assigned to a coordinate activated by a bonus activation symbol 34, the processor controls the display 10 at 98 to show the cell doors closing. The processor also, with respect to the on-screen bonus, compares the outcome of the spin at 100 to determine if any new bonus activation symbols 34 have been selected. If so, the processor 12 displays at 102 the newly selected activation symbol 34 on the display 10.

In the event the no new coordinates are to be activated at 100, at 104 the score or amount of the on-screen win for the spin are tallied at 104. The amount of the on-screen win, if any, are tallied by comparison of the symbol combinations along activated pay lines to determine all winning line outcomes at 106 and retrieving at 108 for each winning outcome from a data structure storing the winning pay, the pays for each. The processor at 110 also retrieves any on-screen bonus awarded for tallying of the total on-screen win. At 112 the number of credits or coins won is paid and any on-screen pay conditions are at 114 highlighted on the display 10.

In addition to determining any on-screen award to the player, the processor at 116 determines whether any scatter bonus has been triggered by the display of two or more scatter bonus symbols 40 in coordinate locations in the display 10. If such a condition occurs, the scatter bonus is activated and completed as hereinafter described. The processor 12 at 118 displays the primary game and may control the display 10 to highlight the symbols fulfilling the scatter bonus requirements.

Likewise the processor 12 at 120 determines whether any secondary bonus condition has been met, e.g. three or more bonus symbols 38 displayed in adjacent positions on any activated pay line. The condition may require the bonus symbols 38 be displayed in left most reels 28a-c and/or leftmost reels 28c-e. At 122 the processor 12 controls the display to display the secondary bonus screen 56 for the player to make their selection 28 as previously described. At the conclusion of the awards and issuance of any bonuses, the player is prompted to play another spin.

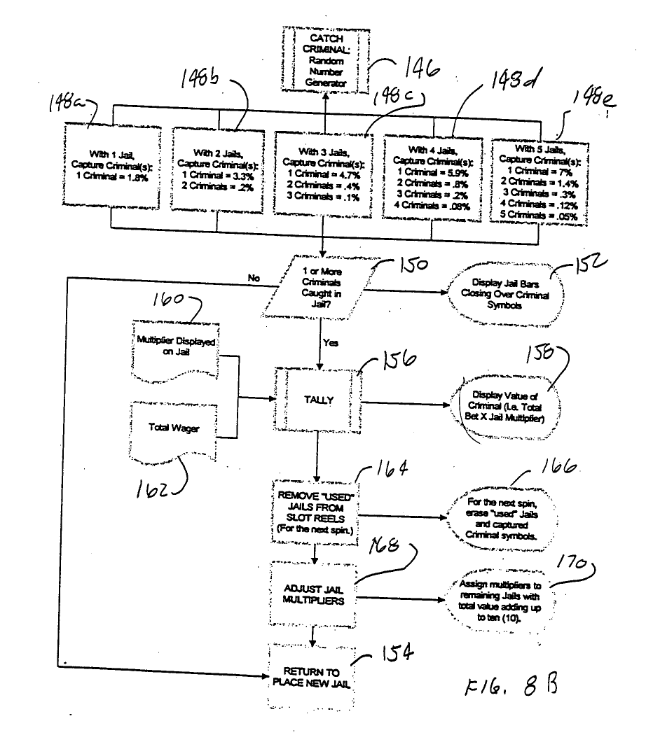

FIGS. 8A and B show an example of the selection of the on-screen bonus. At 124 the processor 12 determines if there are less than five displayed bonus activation symbols 34 displayed, i.e. are less than five coordinates activated. According to the embodiment described herein, if five coordinates are activated, one for each reel 28a-e, no more coordinates can be activated. Further, according to this embodiment, the first activated coordinate will be assigned to and occupy the middle row of the third reel 28c of the display 10. If there are less than five coordinates activated before any spin as indicated by the presence of the bonus activating symbol 34 (jail cell), at 126 the processor determines if more than 0 coordinates are activated and if so, an activation random number generator at 128 is referenced by the processor 12 to randomly determine if a coordinate is to be activated. The random number generator 128 is configured to change the statistical probabilities of selecting a coordinate for activation for each spin based upon the number of coordinates which were activated in prior spins. For example, and as shown in FIG. 8A at 130, with one existing, activated coordinate, the random number generator should select, based upon a statistical distribution of selection versus non-selection, for activation of a second coordinate approximately 25% of the spins, e.g. 1 in four spins. With two existing activated coordinates, the third should be activated 6% of the time at 132, with three activated, a new coordinate should be activated 3% of the time at 134 and if four coordinates had been previously activated, a fifth should be activated at 136 1.5% of the spins.

If a new coordinate is to be activated, the processor places an activator symbol 34 on a reel without a symbol in a random location at 138, displays it at 140 and at 142 returns to the primary game display 10.

At 144 the game may be configured to display the first selected activation symbol in the center coordinate 54 (FIG. 4) of the game matrix 26.

It should be noted that since the selection of coordinates to be activated is independent of the symbols being selected for a particular spin that a coordinate could be activated and triggered in the same spin.

With reference to FIG. 8b there is presented a flow chart for the selection and location of the on-screen bonus triggering symbols 36a-c. At 146 there is shown a trigger symbol and placement random number generator (RNG) 146 (which may be the same RNG as RNG 128). RNG 146 and the processor 12 are configured to statistically provide an on-screen bonus a certain percentage of spins. For example at 148a-e, with one coordinate activated, a triggering symbol is selected and assigned to trigger the on-screen bonus approximately 1.8% of the spins, with 2 coordinates activated the bonus will be triggered for one of the coordinates 3.3% of the spins and both coordinates will be triggered on the same spin 0.2% of the time and so forth. Thus the RNG 146 and processor 12 are configured to statistically predict the occurrence of the on-screen bonus(es).

At 150, if one or more on-screen bonuses are fulfilled at 152 a bonus display sequence is initiated wherein the processor 12 displays the bonus activation symbol 34 jail cell closing in front of the triggering symbol 36a-c outlaw. If there is no bonus triggered the processor 12 returns at 154 to the mode for selection activation of a coordinate.

If an on-screen bonus is triggered at 156 the amount of the bonus is tallied and at 158 the basis for the tally is displayed. As stated above, the amount of the on-screen bonuses may be fixed, depending upon the outlaw (triggering symbol 36a-c) triggering the bonus, or may be in the form of a multiplier. As shown, at 160 the triggering multiplier is displayed and the processor 12 retrieves at 162 the total wager (number of lines enabled times the amount wagered per line) and multiplies the total wager times the indicated multiplier. The product is the tally 156.

At 164 and 166 the processor 12 is configured for the next spin to remove the previously displayed bonus activating symbols 34 (jail symbol) and any triggering symbol 36a-c from the display. The activation multipliers at 168 adjusts and assigns multipliers. According to one embodiment, the processor is configured at 170 such that the total for all multipliers has a sum of a fixed number such as ten. That is, as coordinates are activated, the sum of all activated coordinates will be 10×. If one coordinate is activated, it will have an assigned multiplier of 10×. If two are activated, each coordinate will have, for example, a multiplier of 5× (optionally, it could have been 8× and 2×=10×). Thus the award for an on-screen bonus will be higher when the bonus is triggered by a single activated coordinate.

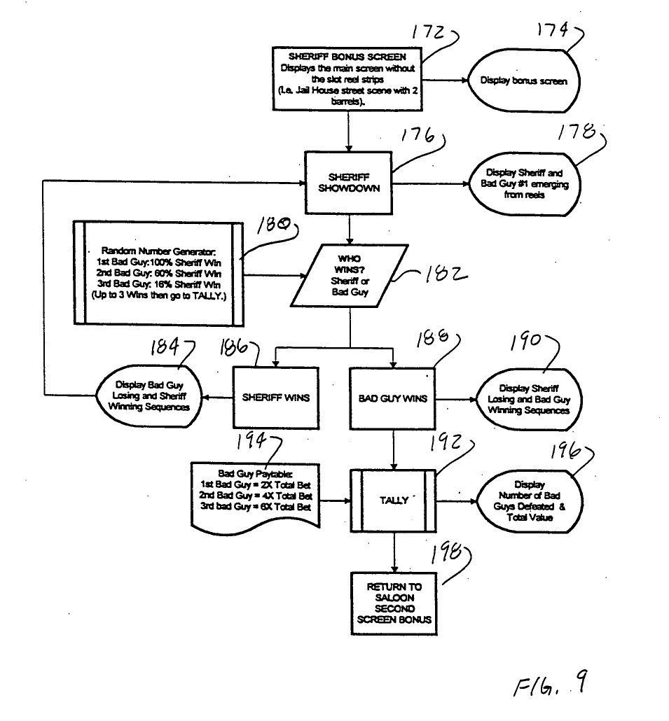

Turning to FIG. 9, the scatter bonus play is illustrated. When the scatter bonus is triggered, the processor is configured to control the display 10 to display the scatter bonus screen at 172, 174. The processor 12 is configured to control the display 10 to display a showdown, scatter bonus sequence, at 176 which includes at 178 a display of a sheriff emerging from a barrel with a first outlaw, e.g. a caricature of bonus triggering symbol 36a (first outlaw) facing off against the sheriff in a western showdown. As shown in FIG. 6, the sheriff faces off against the outlaws as they emerge from opposing barrels. To provide the scatter bonus, the processor 12 includes a random number generator which determines the amount of the bonus. At 180 the processor 12 is configured to, based upon the outlaw, select a bonus. As illustrated in FIG. 6, each outlaw has a different value and the scatter bonus is the total amount for the outlaws defeated by the sheriff. The outlaws emerge as each preceding one is defeated. As shown at 180, the random number generator and processor 12 are configured to have the sheriff defeat the first displayed outlaw 100% of the time, the second displayed outlaw 60% of the time and the third outlaw 16% of the time. At 182, depending on which of the sheriff and outlaw wins, the processor 12 is programmed to display a sequence displaying the outcome, e.g. the sheriff winning at 184, 186 with another outlaw emerging from a barrel or the outlaw winning at 188, 190. The maximum number of outlaws which can be defeated may be fixed such as three outlaws. When all outlaws have been defeated or the sheriff loses a showdown, the bonus is over and the bonus is tallied at 192. The tally may be by assigning to each defeated outlaw a multiplier as suggested at 194. The multiplier would be applied to the player's total wager. The processor 12 controls the display 72 to display the outlaws defeated and the amount of the bonus at 196 and return to the display of the primary game at 198.

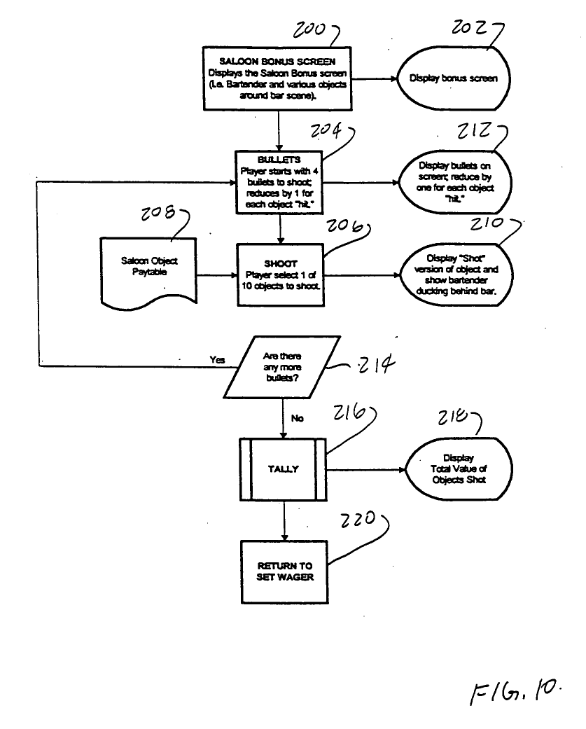

FIG. 10 shows award of the line bonus. When a line bonus condition is fulfilled, the processor 12 at 200, 202 controls the display to display the line bonus screen 56 (FIG. 5). At 204 three pistols 70 are displayed (or four as noted in FIG. 10). The player touches the screen 56 over the intended target in the saloon to shoot the target and reveal the award as represented by a target pay table 208 as well as a display sequence at 210 showing the target being shot. The processor 12 also decrements the number of displayed pistols 70 at 212. After each target is shot, the processor 12 determines at 214 if all three selections (pistols 70) have been used. If not, the player gets another selection. If all selections have been used, the processor 12 at 216 tallies the total award, displays the value of all targets shot at 218 and at 220 returns to the display of the primary game. Each target selected may represent a game multiplier or fixed value bonus, the amounts of which are tied to the amount wagered.

While we have shown and described certain embodiments of the present invention, it should be understood that it is subject to many modifications and changes without departing from the spirit and scope of the appended claims. The game may have any theme, and bonuses can be in the form of fixed values, multipliers, or prizes.

1. (canceled)

2. The apparatus of claim 22 further comprising said processor configured to identify any activated coordinate.

3. The apparatus of claim 2 further comprising said processor configured to control the display to display an indicator at any activated coordinate.

4. The apparatus of claim 3 further comprising said processor configured to control the display to display said activation indicator with any selected game symbol assigned to the activated coordinate.

5. (canceled)

6. (canceled)

7. (canceled)

8. (canceled)

9. (canceled)

10. (canceled)

11. The apparatus of claim 22 comprising said data structure including data corresponding to at least one scatter bonus symbol and said processor configured to issue an award upon obtaining a scatter bonus symbol at a

12. (canceled)

13. (canceled)

14. (canceled)

15. The apparatus of claim 24 further comprising a bet acceptor for a player to input wagers to enable at least one pay line.

16. (canceled)

17. (canceled)

18. (canceled)

19. (canceled)

20. (canceled)

21. (canceled)

22. An electronic apparatus for playing a casino game comprising:
a display;
a data structure storing data corresponding to game symbols and winning symbol combinations, at least one of said game symbols defining a trigger symbol;
a processor to control the display and an input device to prompt the processor for each play of successive hands, when prompted said processor configured to randomly select and assign game and trigger symbol data from said data structure to the coordinates in a displayed X by Y game matrix to display said corresponding game symbol, said matrix displayed to include at least one pay line;
said processor configured to display at least one activated coordinate in the game matrix and to maintain any activated coordinate activated through said successive hands of play;
said processor configured to compare the game symbols displayed on each pay line and to issue an award for any pay line including game symbols corresponding to a predetermined winning game symbol combination, any activated coordinate ignored for the purposes of determining pay line winning combinations and awards; and
said processor further configured to compare the game symbols selected, assigned and displayed in each activated coordinate and if a trigger symbol is selected and assigned to an activated coordinate issuing a triggered award to the player selected from a plurality of available awards.

23. The apparatus of claim 22 comprising said data structure storing data corresponding to a plurality of trigger award symbols and each symbol having a different award value associated therewith, said processor configured to issue a triggered award based upon the trigger award symbol selected and assigned to an activated coordinate.

24. A method for playing a series of game hands on an electronic gaming apparatus of the type having a display and a computer processor to control the display, the method comprising:
storing in a data structure data corresponding to game symbols and winning symbol combinations, at least one of the game symbols defining a trigger symbol;
the player inputting a wager and prompting play each hand of play;
in response to prompting of play the processor randomly selecting and assigning game and trigger symbol data from said data structure to coordinates in a displayed X by Y game matrix to display said corresponding game symbol, said matrix displayed to include at least one pay line;
activating at least one coordinate in the game matrix and maintaining any activated coordinate activated through said successive hands of play;
the processor comparing the game symbols displayed on each pay line and to issue an award for any pay line including game symbols corresponding to a predetermined winning game symbol combination, any activated coordinate ignored for the purposes of determining pay line winning combinations and awards; and
the processor comparing the game symbols selected, assigned and displayed in each activated coordinate and if a trigger symbol is selected and assigned to an activated coordinate issuing a selected one of a plurality of awards.

25. The method of claim 24 comprising configuring said processor to select and assign one of a plurality of trigger award symbols to said activated coordinate, each trigger award symbol having an award value assigned thereto, and issuing a triggered award based upon the value assigned to said trigger award symbol assigned to said activated coordinate.
